(19) United States
(12) Patent Application Publication
(10) Pub. No.: US 2001/0051259 A1
(43) Pub. Date: Dec. 13, 2001

(54) Substrate provided with an anti-reflective coating, and method of providing an anti-reflective coating

(76) Inventors: Arnoldus Wilhelmus Ponjee, Eindhoven (NL); Jeroen Herman Lammers, Eindhoven (NL); Patrick Petrus Johannes Van Eerd, Eindhoven (NL); Thomas Nicolaas Maria Bernards, Eindhoven (NL); Claudia Mutter, Eindhoven (NL); Jozephus Adrianus Maria van den Heijkant, Eindhoven (NL); Michel Josephus Marie Somers, Eindhoven (NL); Leonardus Theodorus Maria Van Hout, Eindhoven (NL)

Correspondence Address: Jack E. Haken, U.S. Philips Corporation, 580 White Plains Road, Tarrytown, NY, 10591, US

(21) Appl. No.: 09/799,832

(22) Filed: Mar. 5, 2001

(30) Foreign Application Priority Data
Mar. 7, 2000 (EP) 00200803.5

(51) Int. Cl. B32B 17/06

(52) U.S. Cl. 428/315.5; 428/428

(57) ABSTRACT

A substrate (22) is provided with a layer (21) comprising organo-metallic components (23) in a solvent having a high-boiling point component (24). As the solvent is removed, the high-boiling point component phase separates, forming larger globules (26) in a matrix (25). The-high-boiling point component is thereafter removed, leaving a matrix (12) of a substance such as SiO₂, in which cavities (13) filled with gas or air of vacuum are present. The cavities have sizes from 5 to 200 nm.

The invention relates to a substrate provided with an anti-reflective coating, the coating comprising a layer with cavities of a medium having a low refractive index and being dispersed within a matrix of a material having a higher refractive index.

The invention further relates to a method of manufacturing an anti-reflective coating on a substrate, a method of manufacturing a display screen for, or of, a display device, and a method of manufacturing a display device, in which method an anti-reflective coating is provided on a display screen of the display device, the coating comprising a layer with cavities of a medium having a low refractive index and being dispersed within a matrix of a material having a higher refractive index.

The invention is of particular importance for a display screen for, or of, a display device.

It is known to provide anti-reflective coatings on substrates. Such anti-reflective coatings reduce the intensity of the light reflected by the substrate. In particular, such coatings are used to increase the ratio between the intensity of light transmitted through a transparent substrate and the intensity of reflected light. This is particularly of great importance in display devices, such as, for instance, LCDs (Liquid Crystal Displays), PDPs (Plasma Display Panels) and CRTs (Cathode Ray Tubes). Such devices comprise a transparent display screen and form an image by generating light at the inner side of the display screen. Said light is transmitted through the display screen. When light from other light sources (including the sun) is reflected at the outer side of the display screen, said reflection is added to the image and the image quality is consequently reduced. Light from other light sources may also be reflected at the rear side (the inner side) of the display screen. Light reflected at such an inner side also reduces the image quality.

One of the ways to reduce the negative effects of light reflection is to provide an anti-reflective coating on the substrate. Such coatings are formed by one or several layers on the substrate which form an interference coating. The intensity of the light reflection is reduced by destructive interference between light rays.

Such anti-reflective coatings ideally have to meet several demands.

The reflection should be appreciably reduced, the costs should not be too high, the manufacturing process should be simple and reliable, the coating itself should not be visible, even when the device is turned off, and it should be wear and tear-resistant.

Many different anti-reflective coatings have been proposed. Although most of them solve one or more of the above problems, the trade-off between reduction in reflection and costs leaves much to be desired. Coatings that provide a strong reduction in reflection are usually (very) expensive. Less expensive coatings do not reduce the reflection to a sufficient extent and are often clearly visible (as a blue hue), especially in the corners of the device. Most customers find a blue hue unattractive, which reduces the intrinsic value of the device.

Japanese patent application no. 3-238740 describes a display device having a reflection-reducing coating, the outer film of which comprises hollow SiO₂ particles having a diameter of 45 nm with air bubbles having an average diameter of 30 nm. Such layers are, however, difficult to make, which would increase the costs and, if made would show relatively large surface unevennesses, resulting in a relatively poor anti-reflective behaviour.

It is an object of the invention to provide a substrate with an anti-reflective coating and a method of providing an anti-reflective coating on a substrate in which a better compromise between costs and positive effects is possible.

To this end, the substrate in accordance with the invention is characterized in that said layer comprises cavities of gas or vacuum enclosed in and/or forming depressions on top of the matrix, but not only in separate spheres, the cavities having an average dimension of 5 to 200 nm.

In the known device, the cavities are incorporated in separate SiO₂ spheres which are mixed in a TEOS solution which is provided on the display screen of a CRT. After drying a layer comprising said spheres in a SiO₂ matrix is provided. Within such a layer, however, the spheres can and will most likely build up locally, sometimes forming a stack of two or three spheres, and sometimes only one sphere or none at all. The diameter of a sphere (45 nm) is comparable to the thickness of the layer (usually between 50 and 100 nm). Thus, the thickness of the layer will show a relatively large unevenness. Furthermore, the hollow spheres will have to be separately made and mixed with the TEOS solution. This adds to the manufacturing costs and necessitates mixing steps, as well as additives mixed in the solution to prevent premature agglomeration of the spheres. Basically, in laymen's terms, the layer may be compared to a paint layer comprising hollow grains, the diameter of the grains being of the order of the thickness of the layer. When the cavities, which may be e.g. gas or vacuum bubbles, are enclosed in the matrix or form depressions on top of the matrix but not only in separate spheres, the thickness variations are reduced. A smoother surface of the layer is provided, thus resulting in a more even thickness.

The method in accordance with the invention is characterized by applying on the substrate a sol-gel solution comprising an organo-metallic compound in a solvent mixture, the solvent mixture comprising a solvent and a high-boiling point component, reducing the solvent content and thus increasing the high-boiling point component content, such that the high-boiling point component phase separates from the solution to form phases of dimension 5 to 200 nm, the organo-metallic compound forming a matrix surrounding and/or underlying said phases, whereafter the high-boiling point component is removed, leaving a layer with cavities of gas or vacuum enclosed in and/or forming depressions on top of the matrix. During formation, the surface of the matrix will be smoothed due to surface tension.

The word “phase” is used here in its meaning of a separate ‘island’ or volume of a material, in this case the high-boiling point material separate from the rest of the solution or matrix. The word ‘high-boiling’ denotes a component having a boiling point which is higher than the (rest of) the solvent (components) or major components of the solvent.

The sol-gel solution is applied on a surface, and thereafter the solution is thickened by removing some of the solvent e.g. by applying heat. The low-boiling point solvent components will be removed first, which will cause the concentration of the high-boiling point component to increase. At a certain time, the high-boiling point component is no longer soluble in the solution and will start to phase separate from the solution, first in very small phases and then coagulating to larger phases. The conditions of the process and the starting composition are chosen to be such that the dimension of the phases grow to 5 to 200 nm. Several examples will be given below.

The invention will be explained in greater detail by means of embodiments given by way of example and with reference to the drawings in which

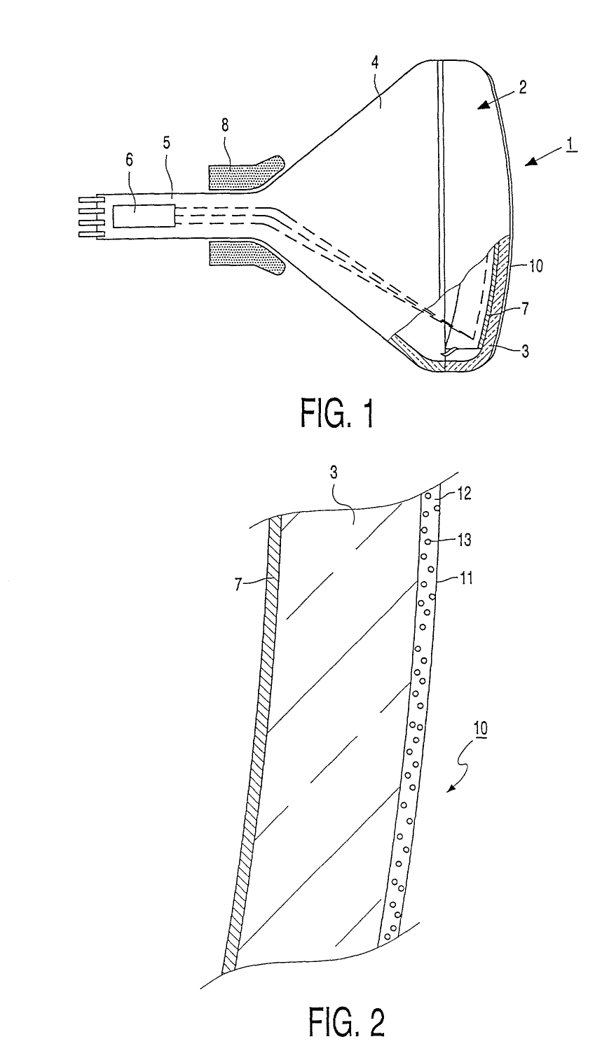

FIG. 1 shows a display device,

FIG. 2 is a sectional diagrammatic view of a display screen of a display device,

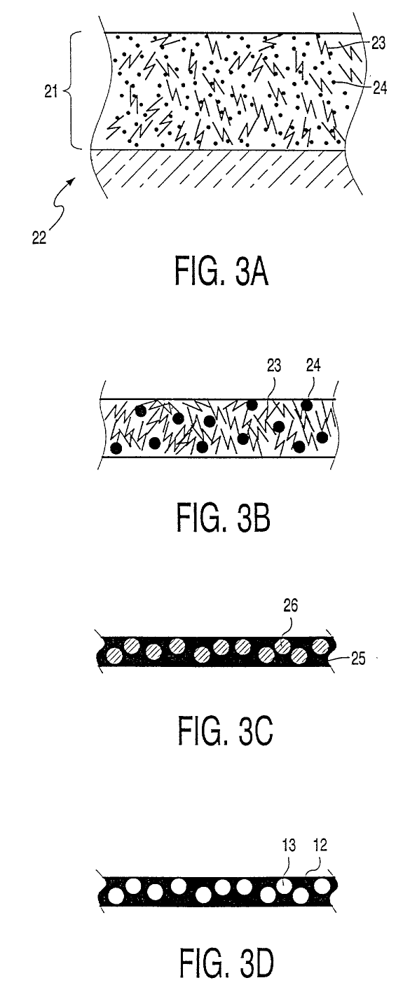

FIGS. 3A to 3D illustrate the method in accordance with the invention,

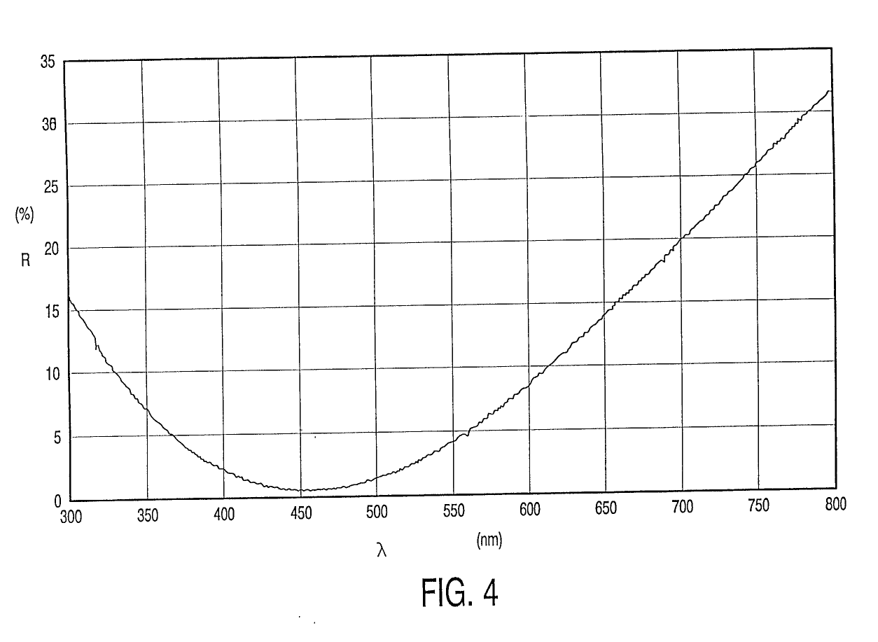

FIG. 4 shows graphically the relation between reflectivity and wavelength for an embodiment of the invention, and

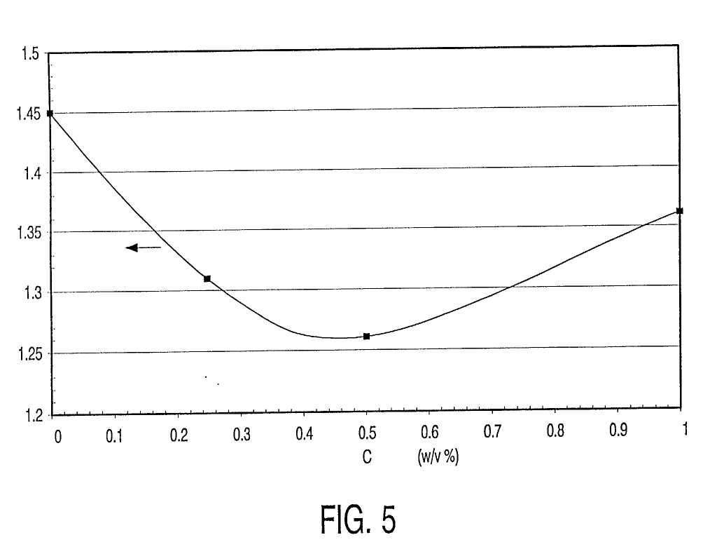

FIG. 5 shows graphically the relation between the apparent refractive index n and the concentration of the high-boiling point component for an embodiment of the invention.

The Figures are not drawn to scale. In the Figures, like reference numerals generally refer to like parts.

FIG. 1 is a diagrammatic cut-away view of a display device, in this embodiment a cathode ray tube 1 having a glass envelope 2 comprising a display screen 3, a cone 4 and a neck 5. The neck 5 accommodates an electron gun 6 for generating one or more electron beams. This electron beam is focused on a phosphor layer 7 on the inner side of the display screen 3. In operation, the electron beam is deflected across the display screen 3 in two mutually perpendicular directions by means of a deflection system 8. The display screen is provided on the outer side with an anti-reflective coating 10 in accordance with the invention.

FIG. 2 shows, in a cross-section, a display screen with an anti-reflective coating. The display device comprises a display screen 3, on the inner side of which a phosphor pattern 7 is provided. An anti-reflective coating 10 is provided on the outer side (the side facing the viewer). In this simple embodiment, the anti-reflective coating comprises only one layer 11, which is a layer in accordance with the invention. In more complicated coatings, the anti-reflective coating could comprise more than one layer, one of the layers being a layer in accordance with the invention. The layer 11 is not drawn to scale and its thickness is greatly exaggerated. The layer 11 comprises a matrix 12 and cavities of gas (for instance, air) 13 are dispersed within the matrix and partially open into the upper surface or lie on the upper surface. Unlike the prior art, these cavities of air are not contained in separate spheres within the layer, but form an integral part of the layer. In laymen's terms, the layer is not akin to a paint layer with hollow grains, as in the prior art, but looks rather like a Swiss cheese having cavities within the layer and partially on the layer. Such a layer has a smoother surface and a more even thickness on the substrate. This makes the optical properties of the layer better controllable and provides better mechanical properties, namely better adhesion and increased strength and craquelé resistance of the layer. In this example, the anti-reflective coating is shown on the outer side of the display screen, i.e. the side facing the viewer. The invention is, however, also applicable to an anti-reflective coating on the inner side of the display screen. The invention is also applicable to other substrates which may benefit from an anti-reflective coating such as, for instance, a cover for a lamp in a traffic tunnel. Application of an anti-reflective coating on such a cover reduces the reflection of light from the lamp (thus increasing the effective light output) and reduces reflection of car head lights on the cover (which may lead to troublesome reflection on walls, etc.).

The sol-gel solution typically comprises an organo-metallic compound such as TEOS (tetraethylorthosilicate) in a solution comprising, for instance, water and ethanol (low-boiling point solvent components) and a high-boiling component.

It is to be noted that the invention is illustrated by means of embodiments, given by way of example, in particular by a display device, more in particular by a CRT. Although the invention and particularly the method of the invention are very well suited for these kinds of devices, because it provides a relatively inexpensive, yet reliable anti-reflective coating, the invention may also be used in a broader field, for instance, in anti-reflective coatings for optical devices or for window panes.

FIGS. 3A to 3D illustrate schematically the method of the invention for forming the layer of the invention.

A relatively thick layer 21 is applied on a substrate 22, typically in a thickness of 10-20 micrometers. The solution comprises organo-metallic component(s) (illustrated in FIG. 3A by zigzag elements 23) and high-boiling point component(s) (illustrated in FIG. 3A by little balls 24) and low-temperature melting point components. As the low-temperature melting point components of the solvent evaporate, the thickness of the layer decreases (see FIG. 3B), the organo-metallic component 23 reacts to form structures and the high-boiling point component(s) phase separates to form larger globules. These phases will at first be very small (smaller than 5 nm), but grow as the process continues. This process continues until the layer is formed substantially to a matrix 25 comprising metal oxide material with globules 26 of a size between 5 and 200 nm in the matrix, although some of said globules may partially lie on the surface (FIG. 3C). The thickness of the layer is typically 50 to 150 nm. The globules are formed by phase separation. If phase separation is to take place, the high-boiling point component should be solvable in the solvent only up to a certain degree. The process of phase separation produces nicely rounded forms for the globules (though they may be ovaloid, especially when the average dimension of the globules is of the same order as the thickness of the layer) and will also yield a relatively smooth (but for the ‘holes and dips’ formed by globules 26) surface of the layer. The average size of the globules depends on a number of parameters, inter alia, the concentration of the high-boiling point component, the onset of the phase separation (which is mainly dependent on the solubility of the high-boiling point component in the solvent), the viscosity of the layer during phase separation and the speed of phase separation. Big (larger than 200 nm) and badly distributed globules mainly occur when the moment of phase-separation (FIG. 3B) occurs at an early stage of the sol-gel process, usually corresponding to a situation in which the high-boiling point component is poorly soluble in the solvent. In these circumstances, the globules are formed at a very early stage and tend to wander through the liquid layer, accumulate and form large and poorly distributed drops. When the additive is present in a large concentration, large globules are formed. Typical concentrations of the high-boiling point component of 0.05-0.75 w/v% are useful for a TEOS concentration of 32 g/l. The hydrolysis time of the hydrolysis mixture influences the speed at which the matrix forms and, to some extent, the viscosity of the layer at the time of phase separation. Finally, the temperature is raised, evaporating the high-boiling point solvent component and leaving a layer comprising a matrix 12 with cavities 13 (FIG. 3D). The size of the cavities is preferably above 5 nm. Evaporating the high-boiling point component becomes difficult for very small globules. In FIGS. 3A to 3D, the layer is applied to manufacture a single-layer anti-reflective coating. For such a coating, the volume fraction of cavities, as will be further discussed below, is preferably such that the apparent refractive index is below 1.3. It is also possible to apply the layer 21 on a layer on a substrate (such as, for instance, a layer comprising ATO or ITO) with a relatively high (higher than 1.6, for instance, approximately 1.8) refractive index. In such circumstances, the refractive index of the layer with cavities is preferably higher (between 1.38 and 1.42).

The average dimension of the cavities may be measured, for instance, as follows:

A SEM photo is made of a layer with a resolution which is high enough to distinguish the cavities on a scale of 1 nm and more. In such a photo taken at more or less right angles to the layer, the cavities are visible, some are directly visible and some can be seen lying under the upper surface of the layer. The diameter of the cavities is measured along a number of lines on the surface (should the cavities be ovaloid, the average of the axes is taken as the diameter). This procedure is repeated until a number of cavities sufficient for calculation of a statistical average is measured. This average is the average dimension of the cavities.

An alternative method, be it a somewhat indirect method, is to measure the reflection characteristics of the coating, which will yield the apparent thickness and the apparent refractive index of the layer. Since the refractive index of the matrix is known the volume fraction of the cavities can be calculated from the apparent refractive index. Using a SEM photo, the average number of cavities per surface area can be measured (counted). Knowing the thickness of the layer, the volume fraction of the cavities, the average number of cavities per surface area, and the average volume per globule can be calculated. The average diameter then follows as the diameter corresponding to a globule with the average volume per globule.

A very coarse method (which may be useful for a quick analysis) is to take a SEM photo and judge the average dimension of the cavities by sight. The human eye and brain is well capable of judging within 10 to 25% the average dimension of the cavities if the spread in size of cavities is not too large. An ‘average cavity’ is then selected and the diameter is measured. For most of the given range, cavity sizes within the indicated range will be distinguished immediately.

It is noted that, for any parameter, each measuring method inherently introduces some statistical errors and thus measurements of dimensions of cavities using different methods will show some deviations.

An example of the method illustrated in FIGS. 3A to 3D will be given below:

A TEOS (tetra-ethylorthosilicate) hydrolysis mixture was made, comprising the following components:

| Hydrolysis mixture: | |
|---|---|
| TEOS | 2 parts by weight |
| EtOH (ethanol) | 1 part by weight |
| HCl solution (0.175M) | 1 part by weight |
| Solvent High-Boiling point material (additive) mixture: | |
| Solvent | 49.2 parts by weight |
| High-boiling point additive | 0.33 parts by weight. |

The water fraction was acidified with HCl to a concentration of 0.175 mole per liter. The hydrolysis mixture was hydrolysed for a certain time, e.g. 1 hour. The additive and the solvent were mixed. The hydrolysis mixture (4 parts) was diluted with the additive/solvent mixture in a 1:12.5 weight ratio. In this experiment, the coating liquids were used within 30 minutes. Glass substrates were cleaned with soap to remove dust. The plates were stored in demi-water, thereafter spun dried (for 20 sec at 1500 rpm). The spinning was stopped, the coating fluid was dosed (in 10 sec at a spinning rate of 100 rpm), the coating was spun out and dried in 150 sec at 120 rpm and the edges were cleaned. The concentration of the additive per 100 ml of solution was 0.5 g per 100 ml, which concentration is denoted herein by a 0.5 w/v% addition. Other additions, for instance, 1.0 w/v% were calculated in the same manner. The concentration of the hydrolysis mixture was also expressed in w/v%. In this case, the concentration of the TEOS hydrolysis mixture was 3w/v%.

FIG. 4 shows the relative reflectivity R in % of the formed layer as a function of the wavelength λ(in nm) when 0.5 w/v% dibutylsebacate (DBS) is used in a 3.0 w/v% TEOS-solution in n-propanol. The hydrolysis time was 1 hour. The vertical axis denotes the relative reflection R, i.e. the reflection normalised to the reflection of an uncoated glass surface, the horizontal axis denotes the wavelength of light in nm. This is a single-layer anti-reflective coating. The characteristics are excellent with a near-zero reflectivity near the most visible part of the visible spectrum and a very broad reflection characteristic. The absolute reflectivity is below 0.5% between 320 and 630 nm, which was hitherto only possible by a double or multi-layer coating. When based on the reflectivity versus wavelength curve and the thickness and the apparent refractive index is calculated, a thickness of 92 nm and a refractive index of 1.26 is found. The apparent refractive index is below the refractive index of the matrix material (which is 1.45) because of the presence of the cavities of air.

This apparent refractive index is calculated from the reflectivity measurements.

FIG. 5 shows, as a function of the concentration of DBS (in w/v%), the apparent refractive index. At zero concentration, the refractive index is the same as that of the matrix (1.45), and as the concentration of DBS increases, the apparent refractive index decreases. However, as the concentration increases further, the increasing concentration leads to an earlier onset of phase separation, leading to bigger and more badly distributed holes (which was also confirmed by microscopic photos), leading to an increase in scattering and relative reflectivity, and thus not to a low apparent refractive index. Preferably, the layer comprising cavities of a medium with a low refractive index has an apparent refractive index which is smaller than 1.3 when the coating is a single-layer anti-reflective coating. In such a case, the reflectivity is strongly reduced, as can be seen in FIG. 4. However, the content of air is relatively high, which makes such coatings relatively vulnerable to scratches. Single-layer anti-reflective coatings may, for instance, be advantageously used on the inner surface of a display window of a display device. Inner surfaces are protected from external influences. When the coating comprises more than one layer, i.e. a layer comprising low index of refraction cavities positioned on top of a layer with a high index of refraction, the layer preferably has an index of refraction between 1.42 and 1.38 (1.38≦n≦1.42). Although the index of refraction is only moderately reduced, the effect of such a layer is appreciable, while the scratch resistance is still sufficient. The cavities having a low refractive index may be filled with air or may be vacuum.

The additives are high-boiling temperature additives and a variety of materials may be used.

Some examples are given below:

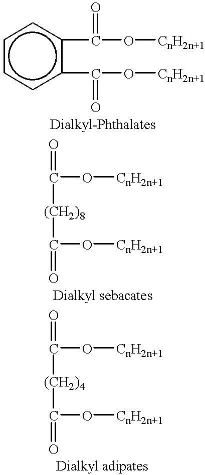

Table 1 below lists some of the possible additives of the types given above, with (for some of the additives) their boiling points in ° C.

TABLE 1

| | Phthalate | Sebacate | Adipate |
|---|---|---|---|
| Dimethyl | 283.7 | | |
| Diethyl | | 312 | 251 |
| Dibutyl | 340 | 344.5 | 305 |
| Diisobutyl | 297 | | |
| Dioctyl | 384 | 256 | |
| Dinonyl | 280 | | |
| Didecyl | 261 | | |

These materials are preferred materials. More in general, the group comprises substances of the general type

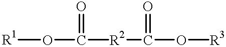

Preferably, subgroups R¹ and R³ are both alkyl groups and preferably the same, in the phthalates subgroup R² is formed by a phenyl-ring, and sebacates and adipates are two examples of the general group in which R² is formed by an alkyl group, and more in particular of the subgroup in said larger subgroup in which the alkyl is a linear alkyl, (CH₂)ₙ, where n=8 and n=4 for the sebacates and adipates, respectively. R² may also be an ether-group.

Substances in which R² is an alkyl or ether group are preferred to phenyl groups because of the possible carcinogenic nature of phenyl compounds. When R² is (CH₂)ₙ n is preferably even. Preferably, R¹ and R³ are the same for ease of manufacture. It is found that, in general, the shorter alkyl side chains (R¹ and/or R³) i.e. methyl, ethyl, butyl, isobutyl are preferred to (i.e. they generally give a lower reflection) longer (octyl, nonyl, decyl etc) side chains because of lower reflectivity results. For the shorter alkyl chains, the minimum in the R curve (see FIG. 4) was approximately 5 to 10%, while it was 20-30% for the longer chain, where R is the relative reflectivity, i.e. the reflectivity as a percentage of the reflectivity of an uncoated substrate. The absolute reflectivity is R times the absolute reflectivity of an uncoated substrate, the latter being approximately 4% for a glass substrate. For example, for 0.5 w/v% DBP (dibutylphtalate) in n-propanol, the minimum in the R curve was measured at 5.5% (thus corresponding to an absolute reflectivity of approximately 0.055*4%=0.2%), while for 0.5 w/v/% DDP (didecylphthalate), the minimum value for R was measured to be 23.2%. The latter value of course still represents a very important 75% reduction in reflection, i.e. a reduction of the absolute reflectivity of approximately 4% to approximately 1%, but less than the result with DBP. Also the scattering produced by the SiO₂ coatings increases with an increasing length of the alkyl side-chain.

Table 2 below gives measurements on the influence of the concentration of DOP (Dioctylphthalate) in n-propanol with a hydrolysis time of 1 hour and measured after a pot-life (time after mixing hydrolysis mixture and solvents and application) of 24 hours.

TABLE 2
influence of DOP concentration on size of globules

| W/v % DOP | Size of globules [nm] |
|---|---|
| 0.50 | 165 ± 30 |
| 0.25 | 80 ± 25 |
| 0.10 | 71 ± 16 |

For some additives, the pot-life (i.e. time between application and mixing of solution) also has an influence on the globule size. In general, a 24-hour or plus pot-life is preferred.

Table 3 illustrates the influence of pot-life on the size of the globules for 0.50 w/v% DOP in n-propanol.

TABLE 3
influence of pot-life on size of globules for 0.50 w/v % of
DOP in n-propanol)

| Pot-life | Size of globules [nm] |
|---|---|
| 42' | 403 ± 50 |
| 105' | 245 ± 82 |
| 24 hr | 165 ± 30 |

In general, the solubility of the additive in the solvent is such that phase separation occurs and occurs at a correct stage, so that the globules with the indicated size are found. A premature phase separation leads to globules that are too large. No phase separation at all has no effect. The moment of phase separation is probably a function of the difference in polar character between the additive and the water and/or silanols in the solution. The bigger the difference in polarity, the earlier phase separation occurs in the gel-formation process. As compared to the longer side chains the shorter alkyl side-chains will cause phase separation at a later moment, because the difference in polarity and water and/or silanol is smaller for the first ones. As a result, smaller and better distributed globules will originate. Thus, using shorter alkyl side chains result in a lower reflectivity.

Using adipates as the head chain results in a higher relative reflection compared to sebacates and phthalates. There is little or no difference between sebacates and phthalates. On the other hand, sebacates and adipates are safer to work with than phthalates, which leads to a preference for using sebacates. To illustrate: 0.5w/v% DBP (Dibutylphthalate in n-propanol results in a minimum relative reflectivity of 0.7%, 0.5 w/v% DBS (Dibutylsebacate) in n-propanol leads to a relative reflectivity of 1.2%, where 0.5 w/v% DBA (dibutyladipate) in n-propanol leads to 27.3%.

Finally, the influence of solvent composition was investigated. Table 4 illustrates the influence of solvent composition, in this example a mixture of 1-propanol with 2-butanol, on the size of the globules.

TABLE 4
influence of solvent on size of globules (0.25 w/v % DOP).

| | Size of globules | Size of globules (30 |
|---|---|---|
| Solvent | (300 hrs' pot-life) | hrs pot-life) |
| 1-propanol | | 165 ± 30 nm |
| 75% 1-propanol-25% 2-butanol | 195 ± 40 nm | 73 ± 10 nm |
| 50%—50% | 177 ± 30 nm | 60 ± 10 nm |
| 2-butanol | 190 ± nm | 60 ± 10 nm |

It will be clear that many variations are possible within the framework of the invention. It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The use of the verb “to comprise” and its conjugations does not exclude the presence of elements or steps other than those stated in a claim.

In summary, the invention (as far as the method is concerned) may be described as follows.

A substrate (22) is provided with a layer (21) comprising organo-metallic components (23) in a solvent having a high-boiling point component (24). As the solvent is removed, the high-boiling point component phase separates, forming larger globules (26) in a matrix (25). The high-boiling point component is thereafter removed, leaving a matrix (13) of a substance such as SiO₂, in which cavities (13) filled with gas or air of vacuum are present. The cavities have sizes from 5 to 200 nm. In this range, the cavities decrease the apparent refractive index, but do not introduce substantial scattering or unevenness of the layer.

1. A substrate (3, 22) provided with an anti-reflective coating (10), the coating comprising a layer (11) with cavities (13) of a medium having a low refractive index and being dispersed within a matrix of a material (12) having a higher refractive index, characterized in that said layer comprises cavities of gas or vacuum enclosed in and/or forming depressions on top of the matrix, but not only in separate spheres, the cavities having an average dimension of 5 to 200 mn.

2. A substrate as claimed in claim 1, characterized in that the cavities have an average dimension of between 10 and 100 nm.

3. A substrate as claimed in claim 1, characterized in that the anti-reflective coating is a single-layer coating, the apparent refractive index of the layer being less than 1.3.

4. A substrate as claimed in claim 1, characterized in that the anti-reflective coating comprises more than one layer, the layer with cavities being positioned on top of a layer having a higher refractive index, the apparent refractive index of the layer with cavities being between 1.42 and 1.38.

5. A display device comprising a display screen provided with an anti-reflective coating (10), the coating comprising a layer (11) with cavities (13) of a medium having a low refractive index and being dispersed within a matrix of a material (12) having a higher refractive index, characterized in that said layer comprises cavities of gas or vacuum enclosed in and/or forming depressions on top of the matrix, but not only in separate spheres, the cavities having an average dimension of 5 to 200 nm.

6. A method of providing an anti-reflective coating (10) on a substrate (3,22) by applying on the substrate (3,22) a sol-gel solution comprising an organo-metallic compound in a solvent mixture, the solvent mixture comprising a solvent and a high-boiling point component, reducing the solvent content and thus increasing the high-boiling point component content, such that the high-boiling point component phase separates from the solution to form phases (26) of dimension 5 to 200 nm, the organo-metallic compound forming a matrix (12) surrounding and/or underlying said phases (26), whereafter the high-boiling point component is removed, leaving a layer (11) with cavities (13) of gas or vacuum enclosed in and/or forming depressions on top of the matrix (12).

7. A method as claimed in claim 6, characterized in that phases are formed with an average dimension of between 10 and 100 nm.

8. A method as claimed in claim 6 or 7, characterized in that the high-boiling point solvent component is one of the group

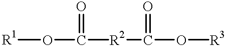

9. A method as claimed in claim 8, characterized in that both R¹ and R³ are alkyl groups, preferably the same group.

10. A method as claimed in claim 8, characterized in that R² is an alkyl group.
